(19) United States
(12) Patent Application Publication
(10) Pub. No.: US 2008/0162748 A1
(43) Pub. Date: Jul. 3, 2008

(54) EFFICIENT POWER MANAGEMENT TECHNIQUES FOR COMPUTER SYSTEMS

(76) Inventor: Blaise Fanning, Folsom, CA (US)

Correspondence Address: KACVINSKY LLC;C/O INTELLEVATE, P.O. BOX 52050, MINNEAPOLIS, MN, 55402, US

(21) Appl. No.: 11/618,878

(22) Filed: Dec. 31, 2006

(51) Int. Cl. G06F 5/00

(52) U.S. Cl. 710/52

(57) ABSTRACT

Techniques involving power management techniques in computer systems are disclosed. For instance, an apparatus may include an input output queue (IOQ), an interface coupled to a processor, and a control module. The interface communicates with the processor regarding power states of the processor. The control module may initiate draining the IOQ upon a commencement of a power state transition for the processor. The control module allows the transition of the processor to continue during the draining of the IOQ. However, at a particular point in the transition, the control module may determine whether the IOQ is empty. If so, then the control module may allow the transition of the processor to continue. Otherwise, the control module may stop the transition of the processor until the IOQ is empty.

### BACKGROUND

As the trend toward advanced central processing units (CPUs) with more transistors and higher frequencies continues to grow, computer designers and manufacturers are often faced with corresponding increases in power and energy consumption. Furthermore, manufacturing technologies that provide faster and smaller components can at the same time result in increased leakage power. Particularly in mobile computing environments, increased power consumption can lead to overheating, which may negatively affect performance, and can significantly reduce battery life. Because batteries typically have a limited capacity, running the processor of a mobile computing system more than necessary could drain the capacity more quickly than desired.

Thus, systems may attempt to conserve power by placing processors in various power states based on various operating characteristics. Such states may include an active (or full power) state, as well as various lower power states. Each of these lower power states may provide a corresponding subset of predefined processor capabilities. Often a processor may transition from a particular power state to one or more lower power states. Reducing the latencies of such transitions can improve a processor's power efficiency.

### BRIEF DESCRIPTION OF THE DRAWINGS

FIG. 1 is a diagram of an exemplary embodiment.

FIG. 2 is a diagram illustrating various states.

FIG. 3 is a diagram of a logic flow embodiment.

FIG. 4 is a diagram illustrating a signaling embodiment.

FIGS. 5A and 5B are diagrams illustrating exemplary operational sequences.

### DETAILED DESCRIPTION

Various embodiments may be generally directed to power management techniques in, for example, computer systems. For instance, in embodiments, an apparatus may include an input output queue (IOQ), an interface coupled to a processor, and a control module. The interface provides for communication with the processor regarding power states of the processor. The control module may initiate draining (or flushing) of the IOQ upon a commencement of a power state transition for the processor. This transition may be from a first power state to a second lower power state.

The control module allows the transition of the processor to continue during the draining of the IOQ. However, at a particular point in the transition (e.g., before entry into a C3 state) the control module may determine whether the IOQ is empty. If so, then the control module may allow the transition of the processor to continue. Otherwise, the control module may pause the transition of the processor until the IOQ is empty.

As described herein, embodiments may provide for faster power state transitions. This may advantageously reduce power consumption and heat dissipation.

Embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

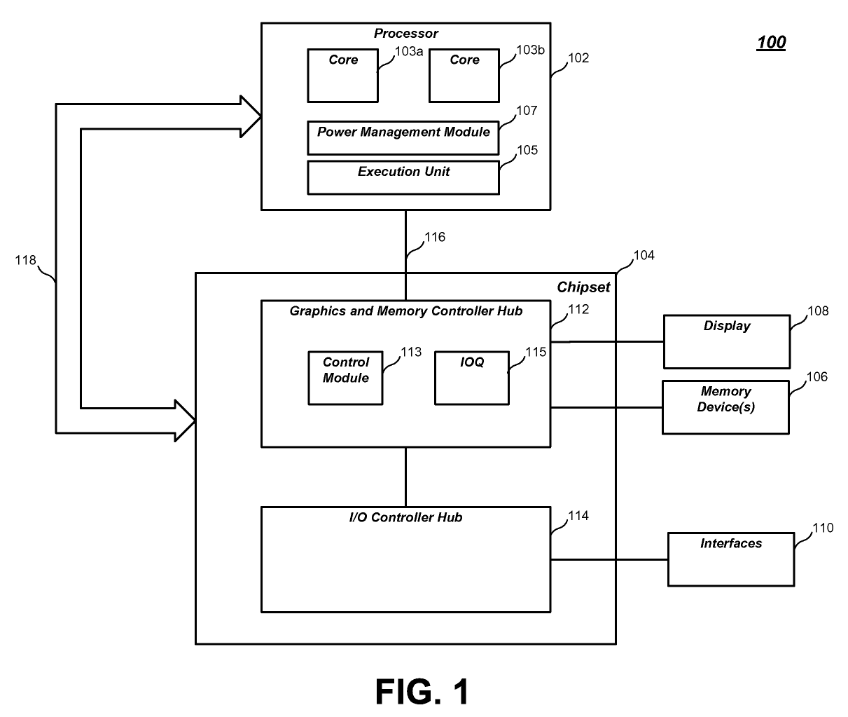

FIG. 1 illustrates an embodiment may operate according to a power management policy involving various operational states. In particular, FIG. 1 shows an system 100 comprising various elements. The embodiments, however, are not limited to these depicted elements. As shown in FIG. 1, system 100 may include a processor 102 a chipset 104, one or more memory device(s) 106, a display 108, and one or more interfaces 110. These elements may be implemented in hardware, software, firmware, or in any combination thereof.

Processor 102 may be a microprocessor. For example, processor may include one or more processing cores 103 and an execution unit 105 to process instructions. As shown in FIG. 1, processor 102 may include further include a power management module 107 to manage power states for core(s) 103. Also, processor 102 may include one or more caches (not shown). These cache(s) may include level 1 and/or level 2 caches.

FIG. 1 shows that processor 102 is coupled to chipset 104 by an interface 116. This interface may be, for example, a front side bus. Chipset 104 may include various components. For example, chipset 104 may include a memory controller hub 112 and an input/output (I/O) controller hub 114.

Memory controller hub 112 (also referred to as the northbridge) handles communications between processor 102 and memory devices (e.g., random access memory (RAM)) 106. Memory controller hub 112 may also handle communications with display 108. Such communications may be through a graphics processor (not shown).

As shown in FIG. 1, memory controller hub 112 may include a control module 113. Control module 113 may be implemented in hardware, software, firmware, or any combination thereof. Further, memory controller hub 112 may include a buffer or cache 115 (such as an input output queue (IOQ)). This component, like a prefetch buffer, may operate as a pipeline to buffer outstanding transactions.

Moreover, memory controller hub 112 may also handle communications with I/O controller hub 114 (also referred to as the southbridge). I/O controller hub 114 may provide connectivity for various system interfaces, such as universal serial bus (USB) ports, a peripheral component interconnect (PCI) bus, and so forth.

As shown in FIG. 1, processor 102 may receive information from and/or send information to chipset 104 (for instance, hub 112) across a “sideband” 118 Sideband 118 may be in the form of one or more signal lines. However, the embodiments are not limited as such. Power management information may be sent across sideband 118. Such power information may relate to power state transitions of processor 102.

Thus, chipset 104 may be involved in power state transitions of processor 102. Such involvement may be handled by control module 113. For instance, hub 112, through operations of control module 113, may empty (flush or drain) the contents of IOQ 115. This may involve storing the contents of IOQ 115 in system memory, such as in memory device(s) 106. The draining or flushing of IOQ 115 may be preceded by a disabling of associated snoops. In embodiments, such actions are handled in an efficient manner to reduce delays associated with power state transitions.

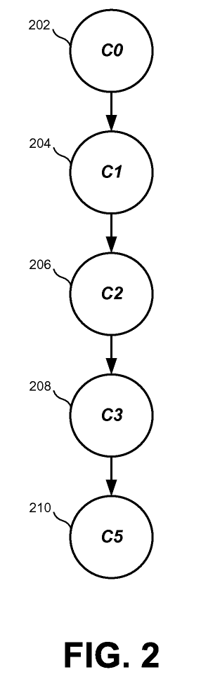

FIG. 2 is a diagram showing operational states that may be employed in power management policies for a processor. Also shown are exemplary transitions between the depicted states. As shown in FIG. 2, a C0 state 202 provides for normal operations (also referred to as an active mode). In this state, a processor (e.g., processor 102) may actively process instructions. Also, the processor may be in a high-frequency mode (HFM), which provides a maximum operating voltage and frequency pairing. Thus, C0 state 202 is referred to as a full power state.

In order to conserve power and/or reduce thermal load, the processor may transition into lower power state(s). For example, the processor may transition from C0 state 202 to a C1 state 204. In this state, portions and/or circuitry of the processor may be powered down. Also, local clocks may be gated.

FIG. 2 shows a C2 state 206, which is also referred to as the stop grant or sleep state. In C2 state 206, portions of the processor 205 circuitry may be powered down and internal and external core clocks may be gated.

A C3 state 208 is referred to as a deep sleep state. In the deep sleep state, internal processor circuitry may be powered down. Also, phase-lock loops (PLLs) in the processor may be disabled.

A C5 state 210 is further shown in FIG. 2. In this state, the entire contents of the processor have been flushed and the caches are empty.

FIG. 2 shows that a processor may transition from C0 state 202 to C5 state 212. In particular, FIG. 2 shows a sequential transition which involves intervening transitions between states C1, C2, and C3. However, this is shown for purposes of illustration and not limitation. Thus different transitions sequences may occur. Also, various transitions from lower power states to higher power states may occur. Moreover, embodiments are not limited to the combination of states shown in FIG. 2. Thus, embodiments may include additional states (e.g., a C6 state), as well as omit certain illustrated states.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context. For instance, the transition may be from a C0 state to a C6 state.

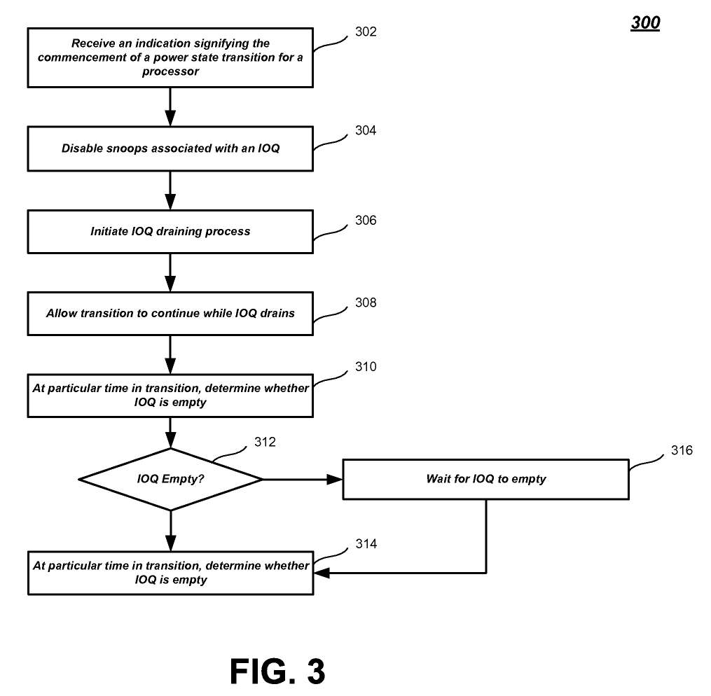

FIG. 3 illustrates one embodiment of a logic flow. In particular, FIG. 3 illustrates a logic flow 300, which may be representative of the operations executed by one or more embodiments described herein. As shown in logic flow 300, a block 302 receives an indication signifying the commencement of a power state transition for a processor. This indication may be in the form an input/output (I/O) read from the processor. Such an I/O read may specify certain characteristics of the transition.

The power state transition may be from a first power state to a second lower power state. For example, the transition may be from a C0 state to a C5 state. However, the embodiments are not limited to this transition.

Upon or after receiving this indication, a block 304 disables snoops associated with the IOQ. Also, a block 306 initiates an IOQ draining process. A block 308 allows the transition of the processor from the first power state to the second lower power state to continue during the draining of the IOQ.

However, at a particular time (e.g., at a time prior to entry into a C3 state), a block 310 determines whether the IOQ is empty. As indicated by a block 312, if the IOQ is empty, then a block 314 allows the processor's power transition to continue. Otherwise, a block 316 pauses the transition and waits until the IOQ is empty.

With reference to FIG. 1, logic flow 300 may be implemented by chipset 104. More particularly, logic flow 300 may be implemented by control module 113 within hub 112. The embodiments, however, are not limited to this context.

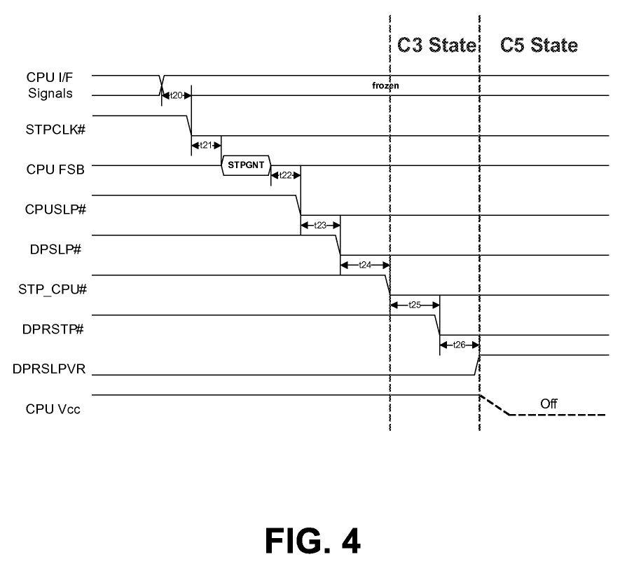

FIG. 4 is a diagram illustrating an example of a transition sequence between a C0 state and a C5 state. This sequence is illustrated in the context of various signals. With reference to FIG. 1, these signals may be transferred across sidebands 118. FIG. 4 further shows multiple time intervals. Listed in chronological order, these time intervals are t20, t21, t23, t24, t25, and t26.

In embodiments, transitions between the C0 state and the C5 state are initiated by a I/O read operation from a processor. With reference to FIG. 1, this I/O read may be from processor 102 to hub 112. This I/O read operation is typically executed only after the processor's cache(s) have been emptied. An example of this I/O read is shown in FIG. 4 as occurring on or before time interval t20.

At this, an IOQ may be handled in various ways. For instance, certain techniques may disable snoops and perform IOQ flushing during the time interval at the commencement of the transition (e.g., at t20). In other words, certain techniques may employ a number of steps to immediately flush the IOQ and disable all snoops as soon as a C5 transition (e.g., a transition from C0 to C5 states) has been requested.

However, in embodiments, such flushing is not performed at this point. Instead, an IOQ is allowed to drain naturally during subsequent time intervals (e.g., intervals t22, t23, and t24).

This technique delays the processor and/or system dependency on an empty IOQ for a significant time. Moreover, this technique may substantially reduce the probability that the processor or system will need to delay a power transition in order to wait for the IOQ to finish draining.

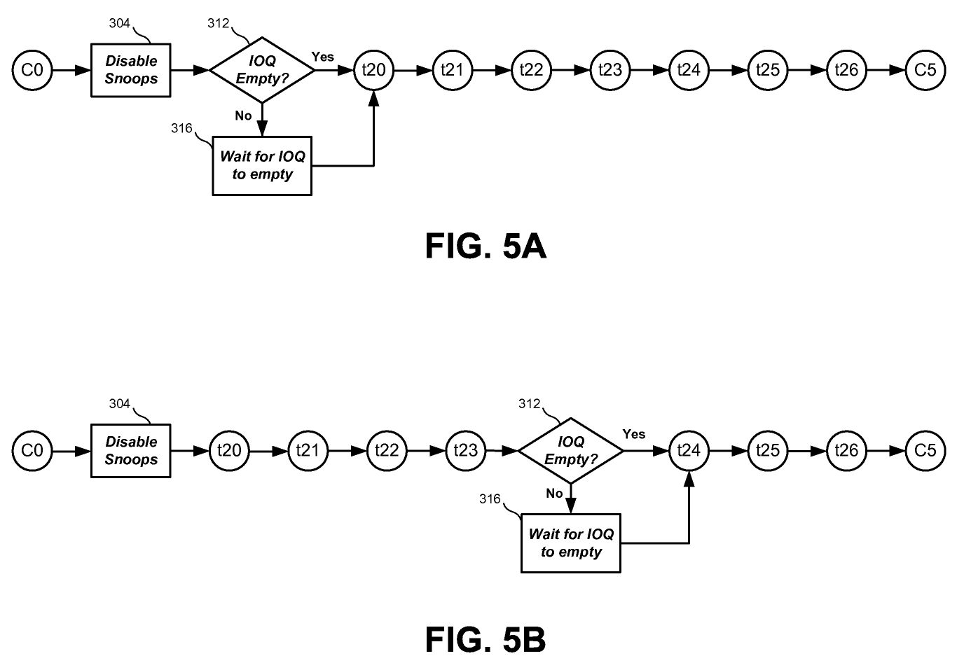

FIGS. 5A and 5B are diagrams illustrating examples of the aforementioned techniques. In particular, these diagrams place certain blocks of FIG. 3 into the time sequence of FIG. 4.

For instance, FIG. 5A shows blocks 304, 312, and 316 being implemented before time interval t20. FIG. 5B also shows block 304 being implemented prior to time interval t20. However, in contrast with FIG. 5A, FIG. 5B shows blocks 312 and 316 being implemented between t23 and t24.

Thus, the example of FIG. 5B shows that IOQ draining or flushing may occur “in parallel” with portions of a processor's power state transitions. This may advantageously shorten the duration of such transitions and further reduce power consumption.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
an input output queue (IOQ); and
an interface coupled to a processor, the interface to provide for communication with the processor regarding power management activities of the processor;
a control module to initiate an IOQ draining process upon commencement of a power state transition for the processor, the transition from a first power state to a second lower power state;
wherein the control module to provide for the transition of the processor from the first power state to the second lower power state to continue during the draining of the IOQ.

2. The apparatus of claim 1, wherein the second lower power state is a C5 state.

3. The apparatus of claim 2, wherein the control module is to:
at a time prior to entry into a C3 state, determine whether the IOQ is empty;
allow the transition of the processor to continue when the control module determines that the IOQ is empty; and
otherwise pause the transition of the processor until the IOQ is empty.

4. The apparatus of claim 3, wherein the first state is a C0 state.

5. The apparatus of claim 1, wherein the control module is to disable snoops associated with the IOQ upon commencement of the power state transition for the processor

6. The apparatus of claim 1, wherein the control module is to receive an input/output (I/O) read from the processor, the I/O read indicating commencement of the power state transition of for the processor.

7. The apparatus of claim 1, wherein the interface includes one or more sideband signal lines.

8. A method, comprising:
initiating an IOQ draining process upon commencement of a power state transition for the processor, the transition from a first power state to a second lower power state; and
allowing the transition of the processor from the first power state to the second lower power state to continue during the draining of the IOQ.

9. The method of claim 8, wherein the second power control state is a C5 state.

10. The method of claim 9, further comprising:
at a time prior to entry into a C3 state, allowing the transition of the processor to continue upon a determination that the IOQ is empty; and
otherwise pausing the transition of the processor until the IOQ is empty.

11. The method of claim 10, wherein the first power control state is a C0 state.

12. The method of claim 8, further comprising:
disabling snoops associated with the IOQ upon commencement of the power state transition for the processor

13. The method of claim 8, further comprising:
receiving an input/output (I/O) read from the processor, the I/O read indicating commencement of the power state transition of for the processor.

14. A system, comprising:
a processor;
a chipset, the chipset including
an input output queue (IOQ); and
a control module to initiate an IOQ draining process upon commencement of a power state transition for the processor, the transition from a first power state to a second lower power state;
wherein the control module to provide for the transition of the processor from the first power state to the second lower power state to continue during the draining of the IOQ.

15. The system of claim 14, further comprising an interface coupled to the processor, the interface to provide for communication with the processor regarding power management states of the processor.

16. The system of claim 15, wherein the interface includes one or more sideband signal lines.

17. The system of claim 14, wherein the control module is to:
at a time prior to entry into a C3 state, determine whether the IOQ is empty;
allow the transition of the processor to continue when the control module determines that the IOQ is empty; and
otherwise pause the transition of the processor until the IOQ is empty.

18. The system of claim 14, wherein the first power state is a C0 state, and the second lower power state is a C5 state.

19. The system of claim 14, further comprising one or more memory devices coupled to the chipset.

20. The system of claim 19, wherein the one or more memory devices comprise random access memory (RAM).
